(19) United States
(12) Patent Application Publication
(10) Pub. No.: US 2014/0378568 A1
(43) Pub. Date: Dec. 25, 2014

(54) RUBBER-REINFORCED STYRENE RESIN COMPOSITION FOR RESIN FOAMS, AND RESIN FOAM

(71) Applicant: NIPPON A&L INC., Osaka-shi, Osaka (JP)

(72) Inventors: Jiichiro Yoshida, Takaishi-shi (JP); Nobuyuki Nakashima, Takaishi-shi (JP)

(73) Assignee: NIPPON A&L INC., Osaka-shi, Osaka (JP)

(21) Appl. No.: 14/372,713

(22) PCT Filed: Jan. 11, 2013
(86) PCT No.: PCT/JP2013/050436

§ 371 Date: Jul. 16, 2014

(30) Foreign Application Priority Data
Jan. 17, 2012 (JP) 2012-007540

(51) Int. Cl. C08L 9/06; C08L 25/12

(52) U.S. Cl. CPC C08L 9/06; C08L 25/12; C08L 2201/08; C08L 2203/14; C08L 2205/025
USPC 521/139; 525/234; 525/233

(57) ABSTRACT

A rubber-reinforced styrene type resin composition for resin foams, the resin foams having a specific gravity of 0.3 to 0.7 and a ratio of the thickness of a skin layer to the thickness of the resin foam of 0.3 to 20%; the composition comprising: 10 to 99% by weight of a rubber-reinforced styrene type resin (A) which is obtained by bulk polymerization of a rubber polymer and an aromatic vinyl monomer, a vinyl cyanide monomer, and if necessary, another monomer that is copolymerizable with these monomers, a weight average particle diameter of the rubber polymer being 0.7 to 3 μm, and 1 to 90% by weight of a copolymer (B) which is obtained by copolymerizing an aromatic vinyl monomer, a vinyl cyanide monomer, and if necessary, another monomer that is copolymerizable with these monomers (with the total of the rubber-reinforced styrene type resin (A) and the copolymer (B) being 100% by weight).

### TECHNICAL FIELD

The present invention relates to a rubber-reinforced styrene type resin composition for resin foams, and a resin foam obtained by foam molding the resin composition.

### BACKGROUND ART

Rubber-reinforced styrene type resins have been used for a wide variety of applications including house building materials, household electric appliances, automobile interior and exterior parts, and the like due to their excellent mechanical strength and/or moldability. In recent years, demand has grown for resin foams for reducing the weight of automobile interior and exterior parts, for replacing wood in house building material use, and the like, in the context of resource saving. Although foamed molded bodies of polyvinyl chloride resins (hereinafter also called “vinyl chloride resin”), which have an excellent balance of practical strength and light resistance, have been used conventionally for furniture, building materials, daily commodities, and the like, there is a strong demand, from the perspective of environmental pollution due to metal-based stabilizers used as stabilizers for vinyl chloride resins and dioxin that can be generated from incineration of vinyl chloride resins, for a resin foam material that can replace the vinyl chloride resin. For example, in a blind slat, a resin foam using a recycled polyester resin has been proposed as a material for replacing vinyl chloride resin (Patent Document 1).

In addition, punching processability, which is such that a processed cross section of the resin foam can be finely finished without cracking when the resin foam is cut into various shapes, or when the resin foam is partially drilled, is one of the characteristics required for resin foams. A resin composition for low-foam molding in which acrylonitrile-acrylic rubber-styrene resin is used to improve the light resistance has been proposed (Patent Document 2). Furthermore, a foamed body of a resin composition containing a polylactic resin and an organic filler has been proposed (Patent Document 3).

### CITATION LIST

### Patent Literature

Patent Document 1: Japanese Unexamined Patent Application Publication No. 2011-001809A
Patent Document 2: Japanese Unexamined Patent Application Publication No. H07-018107A
Patent Document 3: Japanese Unexamined Patent Application Publication No. 2005-060689A

### SUMMARY OF INVENTION

### Technical Problem

The recycled polyester resin described in Patent Document 1 has an insufficient heat resistance and is required to perform a complex foam molding process. The resin composition described in Patent Document 2 is not satisfactory in terms of punching processability and lightness. The resin composition described in Patent Document 3 has a problem of insufficient lightness at an expansion ratio of two to three times, which is a practical expansion ratio, because of the high density of the non-foamed resin.

An object of the present invention is to provide a rubber-reinforced styrene type resin composition for resin foams that has excellent punching processability in addition to excellent lightness, light resistance, and foam appearance, and a resin foam obtained by foam molding the resin composition.

### Solution to Problem

As a result of extensive study in order to solve the above-mentioned problem, the inventors completed the present invention upon discovering that a rubber-reinforced styrene type resin composition for resin foams that has excellent punching processability in addition to excellent lightness, light resistance, and foam appearance can be obtained by using a particular rubber-reinforced styrene type resin and copolymer.

In other words, the present invention relates to a rubber-reinforced styrene type resin composition for resin foams, the resin foam having a specific gravity of 0.3 to 0.7, and a ratio of a thickness of a skin layer to a thickness of the resin foam of 0.3 to 20%; the rubber-reinforced styrene type resin composition for resin foams comprising: 10 to 99% by weight of a rubber-reinforced styrene type resin (A) which is obtained by bulk polymerization of a rubber polymer and an aromatic vinyl monomer, a vinyl cyanide monomer, and if necessary, another monomer that is copolymerizable with these monomers, a weight average particle diameter of the rubber polymer being 0.7 to 3 μm; and 1 to 90% by weight of a copolymer (B) which is obtained by copolymerizing an aromatic vinyl monomer, a vinyl cyanide monomer, and if necessary, another monomer that is copolymerizable with these monomers (with a total of the rubber-reinforced styrene type resin (A) and the copolymer (B) being 100% by weight); and the present invention also relates to a resin foam obtained by foam molding the resin composition.

### Advantageous Effects of Invention

According to the present invention, a rubber-reinforced styrene type resin composition for resin foams that has excellent punching processability in addition to excellent lightness, light resistance, and foam appearance, and a resin foam obtained by foam molding the resin composition can be obtained.

### DESCRIPTION OF EMBODIMENTS

The present invention is explained in detail below. The rubber-reinforced styrene type resin composition of the present invention is a resin composition characterized by containing a rubber-reinforced styrene type resin (A) and a copolymer (B) as essential components, and as needed, containing an additive such as a reinforcing agent, a filler, an antioxidant, a thermal stabilizer, a ultraviolet absorber, or a lubricant.

—Rubber-Reinforced Styrene Type Resin (A)—

The rubber-reinforced styrene type resin (A), which is one of the components constituting the rubber-reinforced styrene type resin composition of the present invention, can be obtained by bulk polymerization of, in the presence of a rubber polymer, an aromatic vinyl monomer, and a vinyl cyanide monomer, and if necessary, another monomer that is copolymerizable with these monomers.

A rubber polymer used in the rubber-reinforced styrene type resin (A) is not particularly limited, and examples of the rubber polymer include diene rubbers such as polybutadiene rubber, styrene-butadiene rubber (SBR), a styrene-butadiene-styrene (SBS) block copolymer, a styrene-(ethylene-butadiene)-styrene (SEBS) block copolymer, acrylonitrile-butadiene rubber (NBR), and butyl acrylate-butadiene; acrylic rubbers such as butyl acrylate rubber, butadiene-butyl acrylate rubber, 2-ethylhexyl acrylate-butyl acrylate rubber, 2-ethylhexyl methacrylate-butyl acrylate rubber, stearyl acrylate-butyl acrylate rubber, and polyorganosiloxane-butyl acrylate composite rubber; polyolefinic rubber polymers such as ethylene-propylene rubber and ethylene-propylene-diene rubber; and silicone rubber polymers such as polyorganosiloxane rubber. One type or two or more types of these can be used. In particular, polybutadiene rubber, styrene-butadiene rubber, butyl acrylate rubber, and ethylene-propylene-diene rubber are preferable.

Examples of the aromatic vinyl monomer constituting the rubber-reinforced styrene type resin (A) include styrene, α-methylstyrene, o-methylstyrene, p-methylstyrene, vinyl toluene, methyl-α-methylstyrene, brominated styrene, and the like, and one type or two or more types of these can be used. However, in particular, styrene and ca-methylstyrene are preferable.

Examples of the vinyl cyanide monomer constituting the rubber-reinforced styrene type resin (A) include acrylonitrile and methacrylonitrile, and acrylonitrile is particularly preferable.

In addition, examples of the other monomer that is copolymerizable include at least one type of monomer selected from the group consisting of (meth)acrylic ester-based monomers, unsaturated carboxylic acid-based monomer, and maleimide-based monomers. Examples of the (meth)acrylic ester-based monomer include methyl acrylate, ethyl acrylate, butyl acrylate, methyl methacrylate, ethyl methacrylate, butyl methacrylate, and the like. Of these, methyl methacrylate is particularly preferable. Examples of the unsaturated carboxylic acid-based monomer include acrylic acid, methacrylic acid, maleic acid (anhydride), fumaric acid, itaconic acid, and the like. Of these, (meth)acrylic acid and maleic acid (anhydride) are preferable. Examples of the maleimide-based monomer include maleimide, N-methylmaleimide, N-phenylmaleimide, N-(2-methylphenyl)maleimide, N-(4-hydroxyphenyl)maleimide, N-cyclohexylmaleimide, and the like. Of these, N-phenylmaleimide and N-cyclohexylmaleimide are particularly preferable.

From the perspective of punching processability of the resin foam, the rubber polymer and each of the monomers constituting the rubber-reinforced styrene type resin (A) are preferably contained in a manner that from 10 to 40 parts by weight of the rubber polymer, from 40 to 80 parts by weight of the aromatic vinyl monomer, from 10 to 50 parts by weight of the vinyl cyanide monomer, and from 0 to 40 parts by weight of another monomer that is copolymerizable with these monomers are contained per 100 parts by weight of the rubber-reinforced styrene type resin (A).

From the perspective of simultaneously achieving the punching processability and reduction in weight without thickening a skin layer, the weight average particle diameter of the rubber polymer contained in the rubber-reinforced styrene type resin (A) used in the present invention needs to be from 0.7 to 3.0 μm. From the perspective of punching processability, the weight average particle diameter is preferably from 0.8 to 2.7 μm. The weight average particle diameter of the rubber polymer can be adjusted by the mixing intensity of a reaction vessel that pulverizes the rubber polymer, the reaction temperature, or the amount of organic peroxide during the process of manufacturing the rubber-reinforced styrene type resin (A). Specifically, the particle diameter tends to be decreased by increasing the mixing intensity, the particle diameter tends to be increased by increasing the reaction temperature, and the particle diameter tends to be decreased by increasing the amount of organic peroxide. Therefore, by combining these techniques, the weight average particle diameter of the rubber polymer can be adjusted. Here, the weight average particle diameter of the rubber polymer contained in the rubber-reinforced styrene type resin (A) refers to a weight average particle diameter obtained by measuring a solution, in which the rubber-reinforced styrene type resin (A) is dissolved in methyl ethyl ketone, via a laser diffraction-type particle size distribution measurement device.

The rubber-reinforced styrene type resin (A) used in the present invention needs to be obtained by a bulk polymerization method. The rubber-reinforced styrene type resin (A) obtained by the bulk polymerization method is composed of a continuous phase that is a copolymer of an aromatic vinyl monomer, a vinyl cyanide monomer, and if necessary, another monomer that is copolymerizable with these monomers, and a dispersed phase that is a rubber polymer in which the monomers graft to a rubber polymer and by which the copolymer is occluded. Therefore, in comparison to other polymerization methods (e.g. emulsion polymerization), the bulk polymerization method is characterized by a large weight average particle diameter of the rubber polymer, and an excellent punching processability in the resin foam.

—Copolymer (B)—

The copolymer (B), which is one of the components constituting the rubber-reinforced styrene type resin composition of the present invention, is a copolymer of an aromatic vinyl monomer, a vinyl cyanide monomer, and if necessary, another monomer that is copolymerizable with these monomers, and can be polymerized by a conventionally known polymerization techniques including polymerization methods such as an emulsion polymerization method, a bulk polymerization method, a suspension polymerization method, and a solution polymerization method. A combination of copolymers obtained by each of the polymerization methods may be used, or a combination of one type or two or more types of copolymers may be used.

Examples of the monomer constituting the copolymer (B) include an aromatic vinyl monomer, a vinyl cyanide monomer, and another monomer that is copolymerizable. Monomers that are exemplified in the “rubber-reinforced styrene type resin (A)” section can be used as each of these monomers.

The proportion of each of the monomers constituting the copolymer (B) is not particularly limited; however, from the perspectives of polymerization productivity and colorability, the aromatic vinyl monomer is preferably from 50 to 85 parts by weight, the vinyl cyanide monomer is preferably from 15 to 50 parts by weight, and the other monomer that is copolymerizable is preferably from 0 to 35 parts by weight when the total amount of the monomers constituting the copolymer (B) is 100 parts by weight.

The copolymer (B) used in the present invention relates to the foamability and the strength of the foamed body when a rubber-reinforced styrene type resin composition is foam-molded, and has a role of adjusting the melt-kneading torque of the rubber-reinforced styrene type resin composition and adjusting the content of the rubber polymer.

The molecular structure of the copolymer (B) may be straight or branched; however, the die swell ratio measured at 220° C. and at 10 kg is preferably from 1.3 to 4.0. If the die swell ratio of the copolymer (B) is in the above range, the balance between the resin pressure and the viscosity of the molten resin during the foam molding is good, and the foam appearance and punching processability are enhanced because closed cells are readily formed. The die swell ratio is more preferably from 1.4 to 3.6.

The rubber-reinforced styrene type resin composition of the present invention contains the rubber-reinforced styrene type resin (A) and the copolymer (B) as essential components, and if necessary, an additive may be contained. However, from the perspectives of the productivity and punching processability, the proportion of the rubber-reinforced styrene type resin (A) needs to be from 10 to 99% by weight, and the proportion of the copolymer (B) needs to be from 1 to 90% by weight when the total amount of the rubber-reinforced styrene type resin (A) and the copolymer (B) is 100 parts by weight. The rubber-reinforced styrene type resin (A) is preferably from 20 to 80% by weight, and the copolymer (B) is preferably from 20 to 80% by weight; and the rubber-reinforced styrene type resin (A) is more preferably from 30 to 75% by weight, and the copolymer (B) is more preferably from 25 to 70% by weight.

In the rubber-reinforced styrene type resin composition of the present invention, the amount of the rubber polymer contained in the rubber-reinforced styrene type resin composition is not particularly limited; however, from the perspectives of the light resistance and punching processability, the amount of the rubber polymer is preferably from 3 to 15% by weight, and more preferably from 5 to 12% by weight.

The melt-kneading torque of the rubber-reinforced styrene type resin composition of the present invention is not particularly limited; however, from the perspectives of appearance of the extruded foam, the melt-kneading torque at 180° C. is preferably from 10 to 30 N·m, and more preferably from 15 to 25 N·m. The melt-kneading torque is an indicator of the relative viscosity of the molten resin at a constant temperature, and closely relates to the shear heating of a resin during extrusion foaming molding. In extrusion foaming molding, cooling is required to impart a desired shape to the molten resin containing a foaming gas, which is extruded from a die; however, in the case of a resin composition having a high melt-kneading torque, since the friction between the resin composition and the rotation of screw of the extruder becomes great, heat is readily generated, and cooling will be insufficient leading to the deterioration in the appearance of the extruded foam.

In the rubber-reinforced styrene type resin composition of the present invention, within a range that the purpose of the present invention is not hindered, additives can be added, such as light stabilizers; antioxidants such as hindered phenol-based, sulfur-containing organic compound-based, and phosphorus-containing organic compound-based antioxidants; thermal stabilizers such as phenol-based and acrylate-based thermal stabilizers; ultraviolet absorbers such as benzotriazole-based, benzophenone-based, and salicylate-based ultraviolet absorbers; polyolefin wax; fatty acid metal salts; lubricants such as organic nickel-based lubricants and higher fatty acid amides; plasticizers such as phosphoric acid esters; halogen-containing compounds such as polybromophenyl ether, tetrabromobisphenol-A, brominated epoxy oligomers, and brominated polycarbonate oligomers; phosphorus compounds; flame retardants/flame retardant auxiliaries such as antimony trioxide; colorants such as carbon black, titanium oxide, pigment, or dye; odor masking agents; reinforcing agents or fillers such as talc, calcium carbonate, aluminum hydroxide, glass fibers, glass flakes, glass beads, carbon fibers, and metal fibers.

As additives used in the rubber-reinforced styrene type resin composition of the present invention, from 0.05 to 0.8 parts by weight of the light stabilizer is preferably used, from 0.05 to 0.3 parts by weight of the antioxidant is preferably used, from 0.01 to 0.4 parts by weight of the ultraviolet absorber is preferably used, from 0.5 to 5 parts by weight of the lubricant is preferably used, and from 1 to 20 parts by weight of the filler is preferably used, relative to 100 parts by weight of the resin in which the rubber-reinforced styrene type resin (A) and the copolymer (B) are combined.

The foaming agent used in the rubber-reinforced styrene type resin composition of the present invention is not particularly limited as long as the foaming agent is used as a foaming agent for resins. Examples of the foaming agent for resins include gases such as air, water, nitrogen, carbon dioxide, butane gas, pentane, and chloro-fluorocarbon; inorganic foaming agents such as carbonate and bicarbonate; organic foaming agents such as isocyanates, azo compounds, hydrazine derivatives, semicarbazide compounds, azide compounds, nitroso compounds, and triazole compounds (e.g. p,p′-oxy-bis(benzenesulfonyl hydrazide), azodicarbonamide, sodium bicarbonate, and the like. One of these can be used alone, or two or more types of these can be used in combination. In addition, the foaming agent used in the present invention may be used in the form of a master batch in which these foaming agents are kneaded into a resin. Although the added amount of the foaming agent is adjusted based on the target expansion ratio, the foaming agent is preferably used at 0.01 to 5 parts by weight, and more preferably used at 0.1 to 3 parts by weight, per 100 parts by weight of the rubber-reinforced styrene type resin composition of the present invention.

The mixing method of components such as the rubber-reinforced styrene type resin (A), the copolymer (B), and the additive in the present invention is not particularly limited, and the mixture of these constituents can be mixed using an extruder such as a single screw extruder or a twin screw extruder, a Banbury mixer, a kneader extruder, a pressurized kneader, and a heating roller.

The rubber-reinforced styrene type resin composition of the present invention is used for a resin foam having a specific gravity of 0.3 to 0.7; and a ratio of a thickness of a skin layer to a thickness of the resin foam of 0.3 to 20%. The skin layer refers to the surface layer part that is closer to the surface than the coarse-fine boundary of the foam cells observed on the cross-section of the foamed body, and affects the specific gravity or mechanical strength of the entire foamed body. When the thickness of the skin layer is less than 0.3% relative to the thickness of the resin foam, even if a foamed molded body is obtained by using the rubber-reinforced styrene type resin composition of the present invention, the punching processability and the stiffness of the obtained foamed molded body will be poor. In addition, when the thickness of the skin layer is greater than 20% relative to the thickness of the resin foam, since the specific gravity of the foamed molded body becomes large, this will impair not only the lightness but also the punching processability. Since the stiffness that is sufficient for practical use as a resin foam cannot be obtained in the case where the specific gravity is less than 0.3, and since the lightness will be inferior to a conventional resin foam made from polyvinyl chloride resin that is the target of replacement in the case where the specific gravity is greater than 0.7, the rubber-reinforced styrene type resin composition of the present invention is used for resin foams having the specific gravity of 0.3 to 0.7.

The size and shape of the foamed molded body obtained from the rubber-reinforced styrene type resin composition of the present invention is not particularly limited. Examples include, in the case of a blind slat, a foamed molded body having a thickness of 1.5 to 3 mm and a width of 20 to 60 mm in a flat plate shape; and in the case of an insulating building material, a foamed molded body having a thickness of 3 to 50 mm in plate shape.

The molding method for obtaining a resin foam using the rubber-reinforced styrene type resin composition of the present invention is not particularly limited, and not only conventionally known foam molding methods can be applied but also conventionally known foaming agents can be used to foam the resin composition; however, to further enhance the appearance and the stiffness of the resin foam, the resin foam is preferably obtained using an extrusion foaming molding method by the Celka process which facilitates controlling of the skin layer thickness. The thickness of the skin layer can be controlled by changing a die, the structure of a sizing die, as well as molding conditions such as resin temperature and cooling temperature. By lowering the resin temperature at a die outlet and rapidly cooling by a sizing die, the thickness of the skin layer can be increased.

### EXAMPLES

To describe the present invention in further detail, the present invention is explained below using examples. However, the scope of the present invention is not limited to these examples. Note that “part” and “%” used in the examples are based on weight.

Rubber-Reinforced Styrene Type Resin (A-1)

A raw material consisting of 64.4 parts of styrene, 10.6 parts of acrylonitrile, 10 parts of ethylbenzene, 15 parts of styrene-butadiene rubber, 0.2 parts of t-dodecylmercaptan, and 0.05 parts of 1,1-bis(t-butylperoxy)3,3,5-trimethylcyclohexane was prepared, and using a known bulk polymerization method, a rubber-reinforced styrene type resin (A-1) having a composition ratio of 18% styrene-butadiene rubber, 67% styrene, and 15% acrylonitrile was obtained. The obtained rubber-reinforced styrene type resin (A-1) was dissolved in methyl ethyl ketone (0.01 g/mL), and the weight average particle diameter was measured by a laser diffraction-type particle size distribution measurement device (SALD-1100; manufactured by Shimadzu Corporation). The weight average particle diameter of the rubber polymer of the rubber-reinforced styrene type resin (A-1) was 0.9 μm.

Rubber-Reinforced Styrene Type Resin (A-2)

Polymerization was performed by the same method as described above, except for preparing a raw material consisting of 60.5 parts of styrene, 19.2 parts of acrylonitrile, 10 parts of ethylbenzene, 10.4 parts of styrene-butadiene rubber, 0.2 parts of t-dodecylmercaptan, and 0.05 parts of 1,1-bis(t-butylperoxy)3,3,5-trimethylcyclohexane, and a rubber-reinforced styrene type resin (A-2) having a composition ratio of 14% styrene-butadiene rubber, 65% styrene, and 21% acrylonitrile was obtained. As a result of measuring the weight average particle diameter of the rubber polymer of the obtained rubber-reinforced styrene type resin (A-2) by the same method as for the rubber-reinforced styrene type resin (A-1), the weight average particle diameter was 2.3 μm.

Rubber-Reinforced Styrene Type Resin (A-3)

In a nitrogen purged reaction vessel, 50 parts (solid content) of styrene-butadiene rubber latex having a weight average particle diameter of 0.4 μm, 150 parts of water, 0.1 parts of disodium ethylenediaminetetraacetate salt, 0.001 parts of ferrous sulfate, and 0.3 parts of sodium formaldehyde sulfoxylate were added, and after heating to 60° C., a mixture consisting of 35 parts of styrene, 15 parts of acrylonitrile, and 0.2 parts of cumene hydroperoxide were continuously added over three hours, and the mixture was further polymerized for two hours at 60° C. Thereafter, by performing salting-out, dehydration, and drying, a rubber-reinforced styrene type resin (A-3) having a composition ratio of 50% styrene-butadiene rubber, 35% styrene, and 15% acrylonitrile was obtained.

Copolymer (B-1)

Using a publicly known emulsion polymerization method, a copolymer (B-1) containing 75% styrene and 25% acrylonitrile, and having a reduced viscosity of 1.15 (measured by using a dimethyl formamide solvent at a solution concentration of 0.4 g/dL) was obtained.

Copolymer (B-2)

Using a publicly known emulsion polymerization method, a copolymer (B-2) containing 75% styrene and 25% acrylonitrile, and having a reduced viscosity of 7.50 (measured by using a dimethyl formamide solvent at a solution concentration of 0.4 g/dL) was obtained.

Copolymer (B-3)

Using a publicly known bulk polymerization method, a copolymer (B-3) containing 75% styrene and 25% acrylonitrile, and having a reduced viscosity of 0.44 (measured by using a dimethyl formamide solvent at a solution concentration of 0.4 g/dL) was obtained.

Additives

Inorganic filler: Crown talc PP, manufactured by Matsumura Sangyo K.K.
Light stabilizer: ADEKA STAB LA-77Y, manufactured by Adeka Corporation.
Ultraviolet absorber: Sumisorb 200, manufactured by Sumitomo Chemical Co., Ltd.
Lubricant: ALFLOW H50S, manufactured by NOF Corporation.
Colorant: RTC-30 (titanium oxide), manufactured by Tioxide.

### Foaming Agent

Azodicarbonamide-based foaming agent: Serumaiku MB9043, manufactured by Sankyo Kasei Co., Ltd.

After mixing the rubber-reinforced styrene type resin (A), the copolymer (B), the additive, and the colorant at the composition ratios shown in Table 1 and Table 2, the mixture was mixed for 5 minutes using a mixer, and melt-kneaded at 220° C. by a 40 mm twin screw extruder to form pellets. Thus the rubber-reinforced styrene type resin compositions 1 to 11 were obtained.

TABLE 1

| | Rubber-reinforced styren | | | | | |
|---|---|---|---|---|---|---|
| | type resin compositions | | | | | |
| | 1 | 2 | 3 | 4 | 5 | 6 |
| Rubber-reinforced styrene | | | | | | |
| type resin (A) (part) | | | | | | |
| A-1 | 40 | 40 | 40 | 40 | | 40 |
| A-2 | | | | | 40 | |
| A-3 | | | | | | |
| Copolymer (B) (part) | | | | | | |
| B-1 | 20 | 20 | 20 | 20 | 20 | |
| B-2 | | | | | | 5 |
| B-3 | 40 | 40 | 40 | 40 | 40 | 55 |
| Additive (part) | | | | | | |
| Inorganic filler | 10 | 10 | | | 10 | 10 |
| Light stabilizer | 0.4 | | | 0.4 | 0.4 | 0.4 |
| Ultraviolet absorber | 0.2 | | | 0.2 | 0.2 | 0.2 |
| Lubricant | 2 | 2 | 1 | 1 | 2 | 2 |
| Colorant | 2 | 2 | 2 | 2 | 2 | 2 |
| Die swell ratio of copolymer | 2.1 | 2.1 | 2.1 | 2.1 | 2.1 | 3.3 |
| (B) | | | | | | |
| Weight average particle | 0.9 | 0.9 | 0.9 | 0.9 | 2.3 | 0.9 |
| diameter of rubber polymer | | | | | | |
| (μm) | | | | | | |
| Content of rubber polymer | 6.3 | 6.3 | 7.0 | 6.9 | 4.9 | 6.3 |
| (%) | | | | | | |
| Melt-kneading torque | 21 | 21 | 23 | 23 | 26 | 22 |
| (N * m) | | | | | | |

TABLE 2

| | Rubber-reinforced styrene type | | | | |
|---|---|---|---|---|---|
| | resin compositions | | | | |
| | 7 | 8 | 9 | 10 | 11 |
| Rubber-reinforced styrene type resin | | | | | |
| (A) (part) | | | | | |
| A-1 | | | 90 | 40 | |
| A-2 | 90 | 60 | | | |
| A-3 | | | | | 20 |
| Copolymer (B) (part) | | | | | |
| B-1 | 10 | | 10 | | 30 |
| B-2 | | 5 | | | |
| B-3 | | 35 | | 60 | 50 |
| Additive (part) | | | | | |
| Inorganic filler | 10 | 10 | 10 | 10 | 10 |
| Light stabilizer | 0.4 | 0.4 | 0.4 | 0.4 | 0.4 |
| Ultraviolet absorber | 0.2 | 0.2 | 0.2 | 0.2 | 0.2 |
| Lubricant | 2 | 2 | 2 | 2 | 2 |
| Colorant | 2 | 2 | 2 | 2 | 2 |
| Die swell ratio of copolymer (B) | 1.6 | 3.4 | 1.6 | 1.1 | 2.0 |
| Weight average particle diameter of | 2.3 | 2.3 | 0.9 | 0.9 | 0.4 |
| rubber polymer (μm) | | | | | |
| Content of rubber polymer (%) | 11 | 7.3 | 14 | 6.3 | 8.7 |
| Melt-kneading torque (N·m) | 32 | 33 | 19 | 16 | 27 |

After compounding 1 part of TM-181FSJ (tin-based stabilizer; manufactured by Katsuta Kako Co., Ltd.) as a stabilizer, 0.5 parts of polyethylene wax, 0.2 parts of calcium stearate, and 2 parts of colorant (titanium dioxide) to 100 parts of polyvinyl chloride resin (TH-700; manufactured by Taiyo Vinyl Corporation; degree of polymerization: 700), the mixture was mixed for 5 minutes by a mixer. Thus a polyvinyl chloride resin composition (PVC) was obtained.

### Examples 1 to 10

1 part of foaming agent is compounded in 100 parts of the obtained rubber-reinforced styrene type resin compositions (1 to 10). The mixture was extruded using a non-vent type extruder provided with a sizing die and a Celka process flat-shape die at a tip under the conditions of cylinder temperature of 220° C., die temperature of 150° C., sizing die temperature of 130° C., and screw rotation speed at 30 rpm, and then sufficiently cooled in a water tank to solidify. Thus, resin foams having a width of 50.8 mm and a thickness of 3 mm were obtained.

### Comparative Example 1

Except for using the rubber-reinforced styrene type resin composition 11, the foam molding was performed under the same condition as in Example 1, and a resin foam having a width of 50.8 mm and a thickness of 3 mm was obtained.

### Comparative Example 2

Except for setting the die temperature at 180° C. and the sizing temperature at 160° C., the foam molding was performed under the same condition as in Example 1, and a resin foam having a width of 50.8 mm and a thickness of 3 mm was obtained.

### Comparative Example 3

Except for setting the die temperature at 145° C. and the sizing temperature at 110° C., the foam molding was performed under the same condition as in Example 1, and a resin foam having a width of 50.8 mm and a thickness of 3 mm was obtained.

### Comparative Example 4

Except for using the polyvinyl chloride resin composition (PVC), the foam molding was performed under the same condition as in Example 1, and a resin foam having a width of 50.8 mm and a thickness of 3 mm was obtained.

Measurement of Die Swell Ratio

Using a Semi-Auto Melt Indexer (manufactured by Toyo Seiki Seisaku-sho, Ltd.), the diameter of a strand extruded under the conditions at 220° C., 10 kg, and the diameter of the orifice being 2.095 mm was measured using vernier calipers. The die swell ratio of the copolymer (B) was a numerical value obtained by dividing the strand diameter by the orifice diameter.

In the case where two or more types of the copolymer (B) were used, each of the copolymers (B) were compounded at their prescribed proportions, and then a composition obtained by kneading copolymers (B) for two minutes using a Labo Plastomill (manufactured by Toyo Seiki Seisaku-sho, Ltd.) at 200° C. and 30 rpm was measured in the same manner.

Measurement of Melt-Kneading Torque

The melt-kneading torque of the rubber-reinforced styrene type resin composition was a torque value after kneading for five minutes using a Labo Plastomill (model: 4C150; mixer model: R60; manufactured by Toyo Seiki Seisaku-sho, Ltd.; filling amount: 55.5 g; preheating time: one minute; rotation speed: 30 rpm).

Measurement of Skin Layer Thickness

The thickness of the skin layer was a distance from the surface of a resin foam to a part where density of the foam cells changed, which was determined by magnifying the cross section of the obtained resin foams in the Examples and Comparative Examples using an optical microscope. By determining the thickness of the skin layer, a ratio of the thickness of the skin layer to the thickness of the resin foam was determined.

Evaluation of Foam Appearance

The surface of the obtained foamed molded body was visually evaluated.

A: Surface glossiness was obtained, and the shape of the molded body was accurately formed to the shape of the die.
B: Surface glossiness was somewhat poor, but the shape of the molded body was accurately formed to the shape of the die.
C: Surface glossiness was poor, but the shape of the edge part of the molded body was formed to the shape of the die.
D: Surface glossiness was not obtained, and the edge part of the molded body was rough and not formed to the shape of the die.

Evaluation of Punching Processability

The obtained foamed molded body was fixed on an acrylic resin plate, and punched by placing a punching blade (forging die; L-shaped at 90°) on the surface of the foamed molded body at room temperature. Thereafter, the punched surface was visually evaluated, and the amount of deformation of the cross section of the punched surface was measured by vernier calipers and evaluated.

A: Almost no cracking on the surface and almost no change in the thickness of the cross section were observed.
B: Although no cracking was observed on the surface, the thickness of the cross section was compressed to 2 mm or greater but less than 3 mm.
C: Although no cracking was observed on the surface, the thickness of the cross section was compressed to less than 2 mm.
D: The surface was cracked.

Evaluation of Light Resistance

The obtained resin foam was irradiated for 40 hours using a light resistance testing machine (UVCON; manufactured by Toyo Seiki Seisaku-sho, Ltd.) at the test piece temperature of 60° C. and using the irradiance of 2.5 mW/cm². The change in hue before and after the irradiation was evaluated using a JIS L0804 Grey Scale for Assessing Change in Colour.

A: Very slight change in hue (greater than or equal to grade 4 of the grey scale)
B: Slight change in hue (grade 3-4 of the grey scale)
C: Acceptable level of change in hue (grade 3 of the grey scale)
D: Unacceptable level of change in hue (less than or equal to grade 2 of the grey scale)

Measurement of Specific Gravity

The specific gravity of the resin foam was measured using an electronic densimeter (MD-200S; manufactured by Alfa Mirage Co., Ltd.).

TABLE 3

| | Examples | | | | | | |
|---|---|---|---|---|---|---|---|
| | 1 | 2 | 3 | 4 | 5 | 6 | 7 |
| Rubber-reinforced | | | | | | | |
| styrene type resin | | | | | | | |
| composition | | | | | | | |
| 1 | 100 | | | | | | |
| 2 | | 100 | | | | | |
| 3 | | | 100 | | | | |
| 4 | | | | 100 | | | |
| 5 | | | | | 100 | | |
| 6 | | | | | | 100 | |
| 7 | | | | | | | 100 |
| 8 | | | | | | | |
| 9 | | | | | | | |
| 10 | | | | | | | |
| 11 | | | | | | | |
| PVC | | | | | | | |
| Foaming agent | 1 | 1 | 1 | 1 | 1 | 1 | 1 |
| Ratio of skin layer | 5.0 | 6.8 | 10 | 9.5 | 3.7 | 7.0 | 8.0 |
| thickness relative to | | | | | | | |
| foamed molded body | | | | | | | |
| (%) | | | | | | | |
| Foam appearance | A | A | B | B | A | A | C |
| Punching | A | A | A | A | A | A | A |
| processability | | | | | | | |
| Light resistance | A | C | C | A | A | A | A |
| Specific gravity | 0.37 | 0.38 | 0.47 | 0.46 | 0.42 | 0.52 | 0.40 |

TABLE 4

| | Examples | | | Comparative Example | | | |
|---|---|---|---|---|---|---|---|
| | 8 | 9 | 10 | 1 | 2 | 3 | 4 |
| Rubber-reinforced | | | | | | | |
| styrene type resin | | | | | | | |
| composition | | | | | | | |
| 1 | | | | | 100 | 100 | |
| 2 | | | | | | | |
| 3 | | | | | | | |
| 4 | | | | | | | |
| 5 | | | | | | | |
| 6 | | | | | | | |
| 7 | | | | | | | |
| 8 | 100 | | | | | | |
| 9 | | 100 | | | | | |
| 10 | | | 100 | | | | |
| 11 | | | | 100 | | | |
| PVC | | | | | | | 100 |
| Foaming agent | 1 | 1 | 1 | 1 | 1 | 1 | 1 |
| Ratio of skin layer | 12 | 5.0 | 6.0 | 5.0 | Not | 22 | 5.0 |
| thickness relative to | | | | | observed | | |
| foamed molded body (%) | | | | | | | |
| Foam appearance | B | A | B | B | D | B | B |
| Punching processability | A | B | C | D | D | D | B |
| Light resistance | A | C | A | C | A | A | A |
| Specific gravity | 0.53 | 0.44 | 0.45 | 0.44 | 0.61 | 0.66 | 0.62 |

As shown in Tables 3 and 4, it was found that the rubber-reinforced styrene type resin composition of the present invention was not only excellent in lightness, light resistance, and foam appearance, but also excellent in punching processability. In addition, in the case where the rubber-reinforced styrene type resin composition having a specific structure was used, results for all of these characteristics were excellent. In particular, when compared with Comparative Example 4, the rubber-reinforced styrene type resin composition of the present invention was superior in lightness, foam appearance, and punching processability to the case where the polyvinyl chloride resin composition was used, and was excellent as an alternative material for polyvinyl chloride resins.

As shown in Comparative Example 1, in the case where the rubber-reinforced styrene type resin (A) that was not obtained via the bulk polymerization was used, the result for punching processability was poor. As shown in Comparative Example 2, in the case where, although rubber-reinforced styrene type resin composition 2 was used, the thickness of the skin layer of the foamed molded body was less than 0.3% relative to the thickness of the foamed molded body, the foam appearance and punching processability were poor. As shown in Comparative Example 3, in the case where, although rubber-reinforced styrene type resin composition 2 was used, the thickness of the skin layer of the foamed molded body was greater than 20% relative to the thickness of the foamed molded body, the punching processability and lightness were poor.

### INDUSTRIAL APPLICABILITY

As described above, with the rubber-reinforced styrene type resin composition of the present invention, resin foam that has excellent punching processability in addition to excellent lightness, light resistance, and foam appearance can be easily obtained, and the rubber-reinforced styrene type resin composition of the present invention has high utility value as a resin composition for resin foams.

1. A rubber-reinforced styrene resin composition for resin foams, the resin foam having a specific gravity of 0.3 to 0.7, and a ratio of a thickness of a skin layer to a thickness of the resin foam of 0.3 to 20%; the rubber-reinforced styrene resin composition for resin foams comprising: 10 to 99% by weight of a rubber-reinforced styrene resin (A) which is obtained by bulk polymerization of a rubber polymer and an aromatic vinyl monomer, a vinyl cyanide monomer, and if necessary, another monomer that is copolymerizable with these monomers, a weight average particle diameter of the rubber polymer being 0.7 to 3 μm; and 1 to 90% by weight of a copolymer (B) which is obtained by copolymerizing an aromatic vinyl monomer, a vinyl cyanide monomer, and if necessary, another monomer that is copolymerizable with these monomers (with a total of the rubber-reinforced styrene resin (A) and the copolymer (B) being 100% by weight).

2. The rubber-reinforced styrene resin composition according to claim 1, wherein a content of the rubber polymer is from 3 to 15% by weight.

3. The rubber-reinforced styrene resin composition according to claim 1, wherein a die swell ratio of the copolymer (B) measured at 220° C. and at 10 kg is from 1.3 to 4.0.

4. The rubber-reinforced styrene resin composition according to claim 1, wherein a melt-kneading torque at 180° C. is from 10 to 30 N·m.

5. A resin foam obtained from the rubber-reinforced styrene resin composition described in claim 1, the resin foam having a specific gravity of 0.3 to 0.7, and a ratio of a thickness of a skin layer to a thickness of the resin foam of 0.3 to 20%.

6. The rubber-reinforced styrene resin composition according to claim 1, wherein the rubber-reinforced styrene resin composition is for a resin foam for a blind.

7. The resin foam according to claim 5, wherein the resin foam is for a blind.

8. The resin foam according to claim 5, wherein the resin foam is obtained by a Celka process.

9. The resin foam according to claim 7, wherein the resin foam is obtained by a Celka process.
